(19) United States
(12) Patent Application Publication
(10) Pub. No.: US 2025/0328245 A1
(43) Pub. Date: Oct. 23, 2025

(54) VARIABLE CHUNK SIZE MEMORY COMPRESSION

(71) Applicant: Intel Corporation, Santa Clara, CA (US)

(72) Inventors: Stijn EYERMAN, Evergem (BE); Wim HEIRMAN, Aalter (BE); Vinodh GOPAL, Westborough, MA (US); Wajdi FEGHALI, Boston, MA (US)

(21) Appl. No.: 19/255,057

(22) Filed: Jun. 30, 2025

(51) Int. Cl. G06F 3/06; G06F 12/1009

(52) U.S. Cl. CPC G06F 3/0608; G06F 3/0644; G06F 3/0659; G06F 3/0673; G06F 12/1009

(57) ABSTRACT

Methods and apparatus for variable chunk size memory compression. A physical address space for system memory is partitioned into an uncompressed partition in which data are stored without compression and a compressed partition in which compressed data are stored using a plurality of chunk sizes. In response to a memory Read request, when it is determined that the requested data are stored in a compressed partition, the location of a compressed chunk on a memory device containing the data is determined, the data are retrieved and decompressed, and the decompressed data are returned to the core issuing the memory Read request. A compressed page table (CPT) is maintained containing entries having fields encoding a chunk size, a device address corresponding to a start of the compressed page, and one or more fields denoting sizes of each chunk in the compressed page.

### CROSS-REFERENCE TO RELATED APPLICATIONS

This application contains subject matter that is related to subject matter disclosed in U.S. patent application Ser. No. 19/049,751 filed Feb. 10, 2025, entitled OS-TRANSPARENT MEMORY DECOMPRESSION WITH HARDWARE ACCELERATION.

### BACKGROUND INFORMATION

Memory cost is a growing part of total cost of ownership, due to slow advancements in memory technology and applications with larger memory footprints (e.g., big data and artificial intelligence (AI)). Memory compression reduces memory cost by storing more data in a given capacity. Accessing compressed memory requires decompression, which increases memory access latency and thus decreases performance. To limit the performance impact, in some systems only latency-insensitive data (e.g., cold data, which is accessed infrequently) is compressed, limiting the compressed fraction of an application's memory footprint, and thus limiting the memory capacity and cost savings.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram of an architecture illustrating selective components of the OS transparent decompression scheme, according to one embodiment;

FIG. 2 is a diagram of a CPT entry and its fields, according to one embodiment;

FIG. 3a is a diagram illustrating an example of a compression scheme employing 128 B chunks, according to one embodiment;

FIG. 3b is a diagram illustrating an example of a compression scheme employing 256 B chunks, according to one embodiment;

FIG. 3c is a diagram illustrating an example of a compression scheme employing 512 B chunks, according to one embodiment;

FIG. 3d is a diagram illustrating an example of a compression scheme employing 1024 B chunks, according to one embodiment;

FIG. 3e is a diagram illustrating an example of a compression scheme employing 2048 B chunks, according to one embodiment;

FIG. 3f is a diagram illustrating an example of a compression scheme employing a 4 KB chunk, according to one embodiment;

FIG. 4 is a schematic diagram illustrated selected hardware components of an exemplary computing platform, according to one embodiment;

FIG. 5 is schematic diagram illustrating an SoC implementing a memory coherency architecture employed by the embodiment of FIG. 4;

FIG. 6 is a diagram illustrating a CPT, according to one embodiment;

FIG. 7 is a flowchart illustrating operations and logic performed for a Read request to access data, according to one embodiment

FIG. 8 is a flowchart illustrating operations performed to service a memory Write request that is to be written to memory in the compressed partition; and

FIG. 9 is schematic diagram illustrating a system including a System-on-Package (SoP) having circuitry configured to implement aspects of the embodiments disclosed herein.

### DETAILED DESCRIPTION

Embodiments of methods and apparatus for variable chunk size memory compression are described herein. In the following description, numerous specific details are set forth to provide a thorough understanding of embodiments. One skilled in the relevant art will recognize, however, that the teachings disclosed herein can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

With quickly growing data set sizes (e.g., large databases, large AI models, etc.), memory has become an important component of performance, energy and cost. Compressed memory enables storing more data on the same memory capacity, reducing the memory cost and saving energy by storing and moving data in compressed format. However, it comes with a performance overhead, because data needs to be decompressed before it can be used. To address these issues, some recent and future processors, such as Intel® Xeon® and client systems include compression accelerators (In-Memory Analytics Accelerator (IAA)) that significantly reduce the (de)compression latency versus software (de)compression.

Because accessing compressed memory requires an additional decompression operation, it cannot follow the conventional memory access hardware flow that is implemented in current processors. Therefore, current commercial memory compression implementations (e.g., ZSWAP and ZRAM) use page faults and the operating system (OS) to support memory compression. Data in compressed space is not mapped in the page table (PT), generating a page fault interrupt to the OS when accessed. The OS then looks up the compressed data, performs the decompression (either in software or hardware) and maps the decompressed page to the page table. It also puts the decompressed page in plain (decompressed) DRAM, where it can be accessed in the future without decompression overhead.

Under this scheme there is some reserved space in plain DRAM to store compressed pages. To ensure enough space, the OS regularly scans pages in plain DRAM, and compresses cold pages (that are not recently touched, and thus unlikely to be touched soon) to move to compressed DRAM, leaving space for future decompressions. Ideally, this is done in the background, with no overhead for the running application. However, if the OS is unable to free space quickly enough, and no space is left to put the decompressed page of the current access, it first needs to migrate another page to compressed space, further increasing the latency of accessing compressed data.

Because of this significant overhead, compressed memory is used for data that is accessed very rarely, such as memory-mapped files or administration data (profiling, logging; also called “datacenter memory tax”), and not for data that is actively used by the application. As a result, only a small fraction of memory is used for compression, limiting its capacity gain potential. For example, assuming a compression factor of 5, a 100 GB memory with 20% used for compression maps to 80 GB+5×20 GB=180 GB of available memory space, a 1.8×capacity gain. However, if we use 50% for compression, the available space becomes 50 GB+5×50 GB=300 GB, a 3×gain. Reducing the overhead of accessing compressed memory will enable more compressed data, increasing the available capacity without increasing the physical memory size.

In accordance with aspects of the embodiments disclosed herein, variable chunk size memory compression and decompression schemes are disclosed that enables setting the chunk size differently for individual compressed data structures, to provide a latency versus compression ratio balance. Variable chunk sizes provide low decompression latency for small chunks (sparsely accessed data) and high compression ratio for large chunks (densely accessed data). Variable chunk sizes also enable selecting the most optimal chunk size for each data structure, enabling compression of large parts of the memory with limited performance overhead and a high compression ratio. This reduces memory cost while avoiding/limiting performance degradation.

The memory subsystem of a processor implements a complex interplay of on-chip caching, virtual-to-physical memory address translation and distributed memory locations. At the same time, it is performance-critical. Therefore, most memory schemes are implemented/accelerated in hardware, such as cache coherence, address translation and routing memory operations to the correct location.

Memory compression adds additional complexity because of the extra decompression operation and the larger granularity (compressed pages versus individual cache line accesses). Hence it is implemented in software (in the OS).

Decompression with Variable-Size Chunks

Before explaining the decompression with variable-size chunks scheme, we define a new address space and translation table.

### Compressed Address Space

Under an aspect of our novel scheme, read accesses to compressed data should not generate a page fault, which means that their pages should be mapped in the page table (PT). To that end, we define a new address space, the compressed physical (PHYS_C) space. It contains addresses to compressed data as if these data were not compressed: a byte address maps to a byte in the uncompressed data. Because the data is in fact compressed, these addresses do not directly point to actual locations on the DRAM device, but they are used by the cores to request data from the compressed memory space.

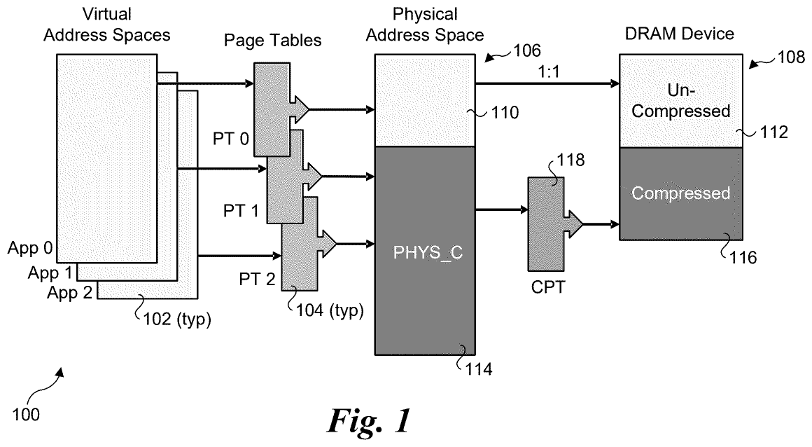

FIG. 1 shows an architecture 100 illustrating selective components of the OS transparent decompression scheme, according to one embodiment. Architecture 100 includes virtual address spaces 102, page tables 104, a physical address space 106, and a DRAM device 108. There is a virtual address space 102 per process, which uses its page table to translate to physical addresses in physical address space 106. As illustrated three virtual address spaces 102 are depicted for respective processes (e.g., applications), labeled App 0, App 1, and App 3, observing that in practice an application may have multiple processes, each of which would be allocated a separate virtual address space. Each of these virtual address spaces will be mapped to pages in physical address space 106 using respective page tables 104, labeled PT 0, PT 1, and PT 2.

The physical address space 106 of a processor that supports transparent decompression is split into two distinct partitions indexed by the most significant (MS) bits of the physical address. The first partition is conventional physical address space 110, i.e., the addresses map directly to a location in uncompressed memory 112 on DRAM device 108, also referred to as “plain” DRAM. The second partition is the PHYS_C space 114, which requires another translation to locate compressed data 116 on memory device 108 and a decompression to obtain the data of the cache line that the core is requesting. We call this secondary translation level the compressed page table (CPT) 118.

The CPT is maintained by the OS, and in one embodiment is stored on a fixed location in memory with a fixed organization, similar to conventional PTs. This enables a hardware CPT walker to translate PHYS_C addresses to the location of the compressed page in memory, similar to the hardware PT walker that is common in current processors.

### Decompression Scheme

Address space setup: A user (or hypervisor) needs to configure how much memory space is reserved for plain DRAM and for compressed DRAM; in one embodiment this configuration is performed at boot time. The plain DRAM partition determines the conventional physical address space. The exact compressed physical space size is not known beforehand, because we do not know the compression factor of the data that will be allocated. This is not an issue, because PHYS_C addresses do not point to actual device locations and the OS can assign PHYS_C addresses as long as there is space in the compressed partition.

Allocation & migration: The OS is still responsible for allocating and migrating data to the plain or compressed DRAM space. When allocating/migrating a page to compressed space, the OS generates a PHYS_C address in the compressed physical space, adds the PHYS_C to the conventional PT with a read-only flag, compresses the page (using software or a hardware accelerator), allocates the compressed page to compressed memory and adds the PHYS_C to device address in the CPT.

Read request: When a core issues a read request to the compressed partition, the virtual address is first translated to the PHYS_C address using conventional PT (and TLBs). If the requested cache line is cached on-chip (local cache or shared LLC), it is fetched from cache like an uncompressed access.

Decompression only needs to be done when the request misses in all cache levels. In that case, the request reaches the memory controller (MC), where it is detected that it belongs to the compressed partition (using the MS bits of the physical address).

Write request: When a core issues a write request to compressed space, it will also pass through the PT/TLB and cause a page fault, because the entry is marked read-only (even if the cache line is cached locally, the page fault occurs). The OS page fault handler recognizes the address as a compressed space address (as opposed to a write to a regular read-only page, which should cause an exception) and resorts to the normal ZRAM/ZSWAP operation: the page is decompressed, put into plain DRAM and the PT is adapted to map the virtual address to a normal DRAM physical address with write permissions. Additionally, it flushes all TLB entries and cache lines that use the previous PHYS_C address.

The embodiments disclosed herein do not support OS-transparent writes to compressed pages, because that requires re-compressing the data, with the possibility that the newly compressed content is larger than the old compressed content, and the page needs to be remapped in compressed space. Instead, we utilize a background demotion policy of the OS that puts the page back in compressed space once it is not touched anymore, performing the compression and mapping in the OS.

### Hardware Additions

A version of the CPT is already maintained by the OS in the conventional schemes, but is not in a fixed standard format on a fixed address in memory. There is only one CPT across the system, compared to one PT per process, as shown in FIG. 1 and discussed above. In one embodiment the CPT is indexed using indexes derived from PHYS_C addresses, which has a smaller address space than the virtual address space. Furthermore, PHYS_C addresses are assigned by the OS, which can be made consecutively to densely fill the CPT. The CPT is therefore significantly less complex than the PT and may be implemented as a single table in some embodiments.

In one embodiment specialized decompressors are implemented in hardware close to the MCs for transparent decompression in addition to existing hardware supporting conventional compression/decompression (such as IAAs) for OS-directed compressions and decompressions. Part of the CPT can also be cached on-chip to speed up the translations, similar to the conventional TLBs. An important difference is that this cache should be kept only at the MCs (or otherwise not part of the CPU core). In some embodiments, the cache is embedded in the memory controller, while in other embodiments the cache is located proximate to the memory controller. In other embodiments, decompression is performed by software.

The decompression scheme also requires software changes in the OS. The operating system needs to implement the concept of PHYS_C addresses, add them in the PT and maintain the CPT. Compressed pages should be marked as such in the PT, such that a write to a compressed page generates a page fault. (The R/W bit cannot be reused for this purpose, because there might be read-only data in compressed space that should cause an actual access violation exception when written to). The page fault handler should correctly interpret writes to compressed space events, e.g., turning them into page migrations. Background migration processes may still be supported, but preferably be adapted to the new scheme, e.g., less aggressively demoting pages and moving write-intensive and beyond-cache reuse pages to plain DRAM.

To compress more data, the decompress latency should be reduced to enable frequent accesses to compressed data with a limited performance impact. Decompress latency can be reduced by compressing data in smaller chunks. For example, a 4 KB page can be compressed in four 1-KB chunks. To access a specific cache line, only 1 of the 4 chunks needs to be decompressed, reducing the decompress latency by ˜4×. If the full page eventually needs to be decompressed (e.g., the full page migrates to uncompressed memory), the chunk with the earliest needed data (the cache line requested by a core) can be decompressed first, serving that request earlier than when decompressing the full 4 KB page in one chunk.

However, smaller chunk sizes have a downside: the smaller the chunk size, the smaller is the compression ratio. Larger chunks have more chances of finding repeating patterns that can be encoded in fewer bits, and their metadata overhead is spread across a larger chunk. Smaller chunks for improving performance reduce the capacity savings, balancing performance and cost.

The performance-cost balance, determining the chunk size, is different for different data access frequencies and patterns. Cold memory, i.e., data that is not accessed frequently (in the current phase of the application), is not sensitive to latency and therefore large chunks are preferable to save as much capacity as possible. Hot memory requires small chunks, because adding latency directly impacts performance. Hot data with locality, i.e., neighboring data is accessed soon after, can spread the decompress latency across multiple requests: if all 16 64 B cache lines in a 1 KB chunk are eventually needed, the average decompress latency per request is only 1/16 of the chunk decompress latency. Therefore, they can tolerate larger chunk sizes, saving more capacity.

An application typically has multiple data structures, each with different access characteristics. It is therefore beneficial to support multiple chunk sizes, each tailored to a specific data structure's characteristics. This flexibility enables the maximum capacity savings with limited performance impact.

### Support for Flexible Compression Chunk Sizes

The embodiments disclosed below describe the infrastructure needed to natively support multiple compression chunk sizes to find the best balance between capacity savings and performance impact. It can be used in the context of high-speed transparent decompression, as described in U.S. patent application Ser. No. 19/049,751 (OS-TRANSPARENT MEMORY DECOMPRESSION WITH HARDWARE ACCELERATION), but it can also be used in other (de)compression implementations too, including software-based decompression implementations. The embodiments focus on storing and retrieving compressed data for decompression in an efficient way. The following aspects outside the scope of this disclosure, and thus not covered and assumed to be existing:

Compression and decompression algorithms and methods: the optimal (de)compression algorithm could depend on the chunk size. We assume that the available software and/or hardware is capable of (de)compressing data using different chunk sizes. The variable chunk size (de)compression schemes disclosed herein are independent of whether decompression is implemented in software or hardware, and of the hardware/software techniques to initiate a decompression (page fault or transparent decompression).

Memory access pattern profiling may be used to determine cold and hot data, and whether or not data has locality, and thus which chunk size is optimal for which data structure. In some embodiments, it is up to the OS, the compiler and/or the programmer to make that decision.

One challenge is to retrieve compressed data based on a request from a core or cache that contains the uncompressed address of the data, i.e., the address the data would have if it was not compressed. The size of the compressed chunk depends on the contents of the chunk: an all-zero chunk can easily be compressed in a single byte, while a perfectly uniformly and independently distributed sequence of 0s and 1s might turn out to be uncompressible. To support maximal capacity savings, in one embodiment all compressed chunks are stored back-to-back, meaning that there is no analytical way to determine the location of the compressed chunk out of the uncompressed address. This is addressed by maintaining a list of mappings between the uncompressed address and the compressed chunk location (similar to the page tables for translating virtual addresses to physical addresses). Each chunk requires its own mapping, i.e., an entry in the list.

The following is assumed for the embodiments disclosed herein:

Data is compressed in page size entities, e.g., a given page either includes at least some compressed data or all data for the page are uncompressed. A page containing at least some compressed data is referred to as a compressed page (observing a portion of a compressed page may contain one or more chunks of uncompressed data). The compression decision is made by the OS, which tracks memory in pages. Whether or not a page is compressed can be tracked in the page table, or by partitioning the physical address space into an uncompressed and a compressed partition, which means the physical address determines if it is compressed or not. Within a compressed page, data can be compressed in multiple chunks that may be the same or differ; the largest possible chunk size is a page (4 KB in most cases), while the smallest chunk size can be up to one 64 B (Byte) cache line.

Compressed chunks are aligned to 64 B addresses, meaning that each chunk starts at a 64 B boundary. Generally, 64 B is the access granularity of DRAM memory, and this alignment ensures that a compressed chunk can be fetched without any overlaps with other chunks (because they end/start on the previous/next 64 B boundary). Furthermore, it also enables storing addresses in 64 B multiples, meaning that we don't need to store the lower 6 bits of the address. Since the minimum compressed chunk size is 64 B, the uncompressed chunk size needs to be larger than 64 B to have capacity savings. This also means that the last few bytes of a compressed chunk up to the next 64 B boundary might be unused if the compressed chunk size is not a multiple of 64 B, slightly reducing the capacity savings compared to the theoretic optimum.

The list to translate uncompressed memory addresses to compressed chunk locations are stored in the CPT. The following provides details regarding how to store compressed data and how to organize the CPT such that it is limited in size (to reduce its memory overhead) and such that it is fast and simple to look up the location of the compressed data.

The smaller the chunk size, the more chunks are needed to cover a certain compressed memory capacity, potentially significantly increasing the size of the CPT. Therefore, we propose to make the CPT size independent of chunk size. Because data is compressed in pages, we propose to have one CPT entry per page, making CPT indexing also independent of the chunk size: it is indexed by the page address. The CPT can be organized as a single direct-mapped table, indexed by adding the physical page identifier to the CPT base address. If there are large unused blocks (‘holes’) in the physical address space, a direct-mapped table might not be memory storage efficient. In that case, a multilevel table is more appropriate, similar to the conventional multilevel virtual to physical page tables (where there are large holes in the virtual address space).

In one embodiment a CPT entry encodes the chunk size and the locations and sizes of each compressed chunk in the page. The sizes are needed to determine the number of 64-B requests to the memory controllers to fetch the compressed chunk from memory. It is assumed that all chunks in a page are compressed using the same (uncompressed) chunk size, assuming that the data in a page likely belongs to the same data structure with the same access pattern.

In the embodiments shown and described herein the size of a CPT entry is fixed, enabling simple bit operations on the address to locate a CPT entry. One embodiment employs 64-bit (8 B) CPT entries, matching the logical unit of a 64-bit processor, but different sizes are possible depending on the supported chunk sizes.

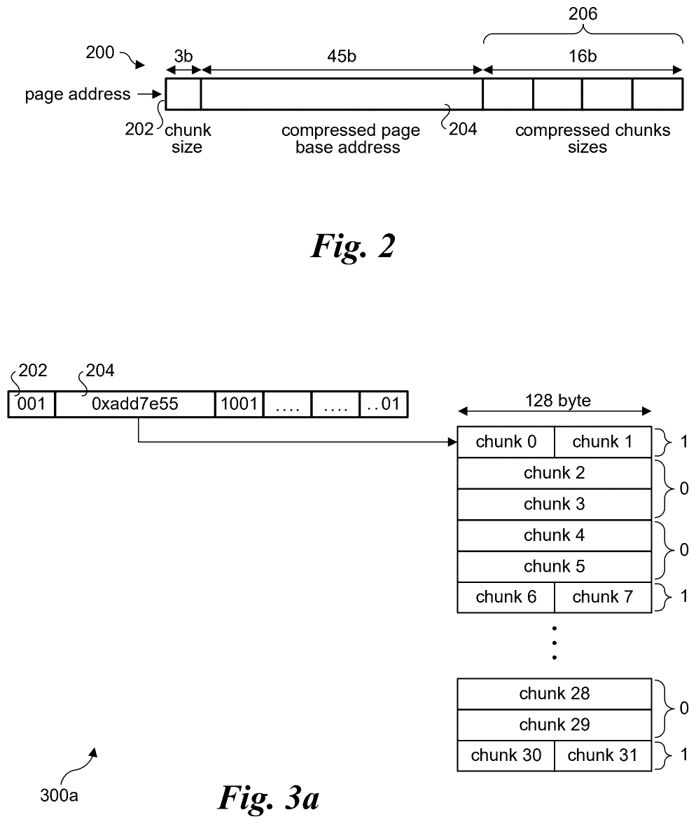

FIG. 2 shows a CPT entry 200 and its fields, according to one embodiment. In general, a CPT entry contains an encoded chunk size field 202 encoding the chunk size, a compressed page base address 204 and one or multiple fields 206 denoting the sizes of each compressed chunk. The first chunk is located at the base address, the second at the base address plus the size of the first, etc. All addresses and sizes are in multiples of 64 B; they should be shifted 6 bits to the left to calculate the actual byte address. Using 45 bits for the address means that we can allocate up to 2 PB of data in the compressed partition (45 bits+6 bits=51 bits). This range can be extended by adding a first level table that contains the first (few) address bit(s) to append in front of the base address.

Under one embodiment, 6 chunk sizes are supported and an invalid identifier is used to support compressed memory systems that require checking the validity/presence of a compressed page. 3 bits are used to represent 8 states. The supported chunk sizes with the 3-bit mode are:
000: invalid
001:128 B chunks
010:256 B chunks
011:512 B chunks
100:1024 B chunks
101:2048 B chunks
110:4096 B chunks
111: no compression

A 64 B chunk size is not supported, because that would lead to <64 B compressed chunks and we assume a minimum DRAM transfer size of 64 B, so transferring <64 B would not provide any bandwidth benefit. The minimum size of a compressed chunk is 64 B, and all compressed chunks are a multiple of 64 B (with possibly a few bytes unused).

In one embodiment 16 bits (or less) are used to indicate the compressed chunk sizes. These bits are defined based on the chunk size:

For 128 B chunks, either compression into 64 B (or less) or no compression is supported. Each 128 B chunk is either mapped onto a 64 B compressed chunk or a 128 B uncompressed chunk. To encode this in the 16-bit field, we pair the 32 128 B chunks (to make a 4 KB page) into 16 pairs. Each pair is either compressed into two 64 B chunks or not compressed into two 128 B chunks, indicated by a 1 or 0 in the 16-bit compressed chunk size field. This means that if one of the two 128 B chunks in a pair is not compressible to at most 64 B, the whole pair is stored uncompressed. Only when both are compressible, they are stored compressed.

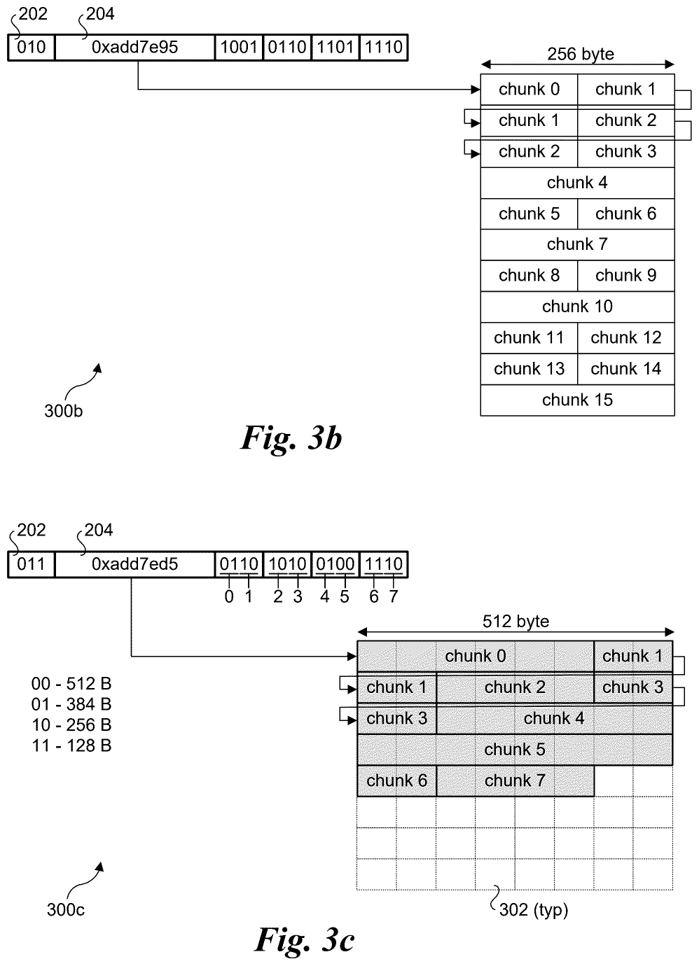

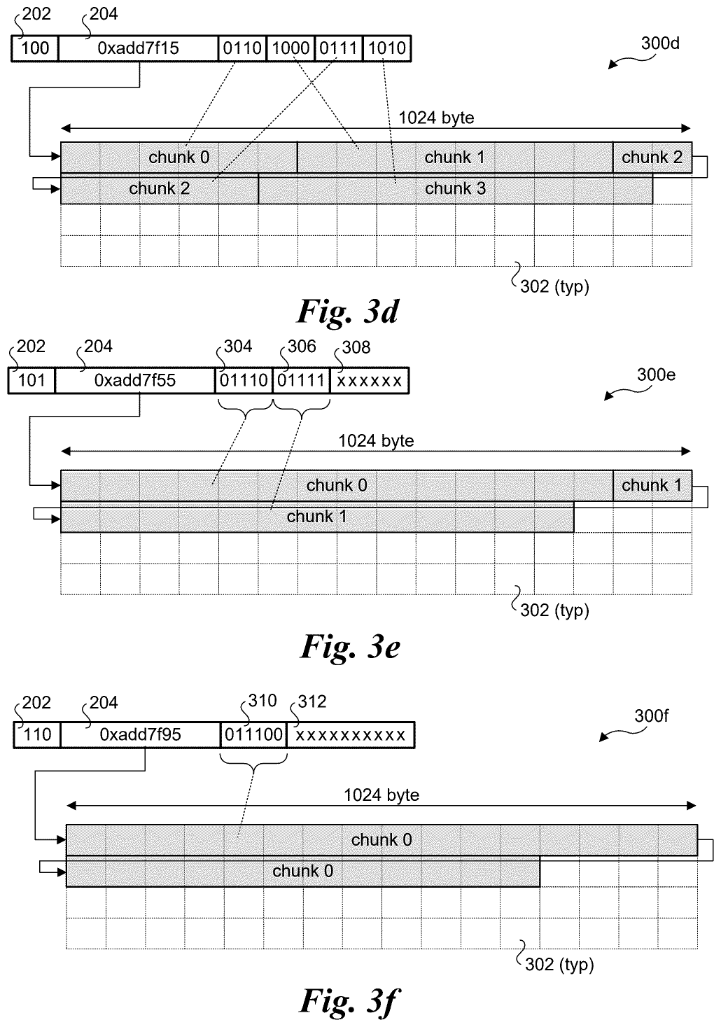

FIG. 3a shows a diagram 300a illustrating an example of a compression scheme employing 128 B chunks. The location of the compressed chunk can be found by adding 64 B for each compressed chunk and 128 B for each uncompressed chunk of the preceding chunks to the base address. For example, considering the first 4-bit size field and 8 chunks, 1001 means that 128 B chunk 0 is stored compressed in 64 B at offset 0, chunk 1 is compressed at offset 64, chunk 2 is uncompressed at offset 128, chunk 3 is uncompressed at offset 256, chunk 4 is uncompressed at offset 384, chunk 5 uncompressed at offset 512, chunk 6 compressed at offset 640 and chunk 7 compressed at offset 704. The effective compression ratio for these first 8 chunks is 8*128 B/(4*64 B+4*128 B)=1.33. For uncompressed chunks, the requested 64 B cache line can be directly sent to the core. For compressed chunks, the 64 B compressed chunk is first sent to the decompressor and decompressed into a 128 B chunk, after which the requested cache line is sent to the core.

As shown in diagram 300b in FIG. 3b, a similar scheme is used for 256 B chunks. The chunks are either compressed into 128 B compressed chunks or not compressed. There are 16 256 B chunks in a page (labeled chunk 0, chunk 1, . . . chunk 15 in diagram 300b), so we can now indicate for each chunk whether it is compressed or not using one bit in the 16-bit compressed chunk size field.

Chunks can be found by either adding 128 B or 256 B to the base address. For the example 4-bit 1001 field, chunk 0 is compressed at offset 0, chunk 1 uncompressed at offset 128, chunk 2 uncompressed at offset 384 and chunk 3 compressed at offset 640. A similar pattern applies to the remaining 12 chunks (chunks 4-15), as defined by 4-bit fields 0110, 1101, and 1110. The compression ratio for the entire page is 16*256 B/(10*128B+6*256 B)=1.45.

128 B chunks and 256 B chunks have the same maximum compression ratio of 2 in this scheme. The advantage of using 256 B chunks is that more chunks will be compressible to 128 B than there are 128 B chunks compressible to 64 B.

FIG. 3c shows a diagram 300c illustrating an example of a compression scheme employing 512 B chunks. There are 8 512 B chunks in a 4 KB page, so we have 2 bits per chunk in the 16-bit field. These can be used to encode 4 compressed chunk sizes, e.g., 128 B (compression factor 4), 256 B (compression factor 2), 384 B (compression factor 1.33) or 512 B (no compression). This example graphically shows the level of compression for the page, which includes sixty-four 64 B cache lines 302 (when uncompressed). The aggregate size occupied by the eight chunks 0-7 is 38*64 B=2432 B. The compression ratio is 4096/2432=1.68.

FIG. 3d shows a diagram 300d illustrating an example of a compression scheme employing 1024 B chunks. For 1024 B chunks, we can encode all compressed chunk sizes from 1 64 B cache line to 16 64 B cache lines (no compression) in the four 4-bit subfields of the 16-bit field. In this example, chunk 0 is encoded as 0110 b (=6 decimal), chunk 1 is encoded as 1000 b (=8 decimal), chunk 2 is encoded as 0111 b (=7 decimal), and chunk 3 is encoded as 1010 b (=10 decimal). The compression ratio=4096/(31*64)=2.06.

FIG. 3e shows a diagram 300e illustrating an example of a compression scheme employing 2048 B chunks. For 2048 B chunks, we only need two 5-bit fields 304 and 306 to encode all 1 to 32 cache line compressed chunk sizes. In this example, chunk 0 is encoded as 01110 b (=14 decimal) and chunk 1 is encoded as 01111 b (=15 decimal). The compression ratio is 4096/(29*64)=2.21. As further shown, the remaining 6 bits 308 are marked ‘x’ to indicate they are ignored.

FIG. 3f shows a diagram 300f illustrating an example of a compression scheme employing a 4096 B (4 KB) chunk. For full page 4 KB chunks, we need 6 bits to encode its size in multiples of 64 B, which are stored in a 6-bit field 310, with the remaining 10 bits 312 marked ‘x’ to indicate they are ignored. In this example, 6-bit field 308 contains 011100 b (=28 decimal). The compression ratio is (4096/28*64)=2.29.

For uncompressed pages (chunk size mode 111), the compressed chunk sizes field is not used. Uncompressed pages can be used for pages that do not meet a certain level of compression (e.g., more than half of the chunks are uncompressible). For these pages, the capacity and bandwidth gains of compression are low, while the lookup and decompression latency overhead (for the compressed chunks) is still there.

Having many different chunk sizes allows the OS/hypervisor or programmer to select the optimal size for each application and data structure. In general, the higher the locality, the larger the chunk size can be, because that increases the compression factor (capacity and bandwidth gains) while diffusing the decompression latency across multiple requests from the cores to the same chunk. Low-locality data structures benefit from smaller chunks, limiting the decompression latency.

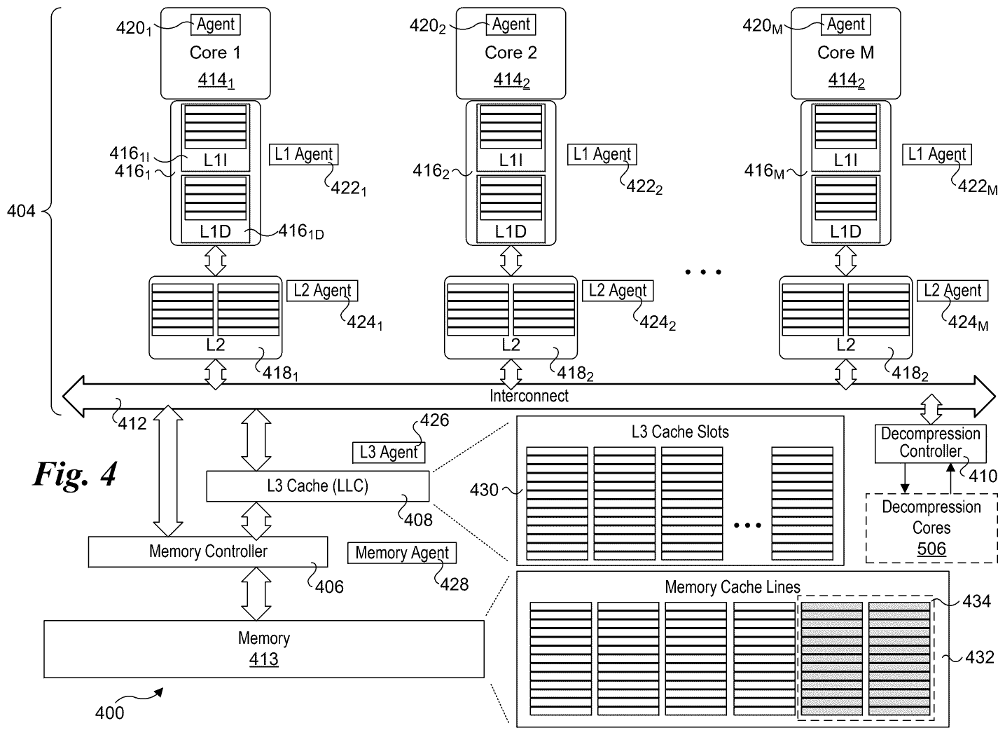

FIG. 4 shows selected hardware components of an exemplary computing platform 400. The hardware components include a CPU having a core 404 coupled to a memory controller 406, a last level cache (LLC) 408 and a decompression controller 410 via an interconnect 412. In some embodiments, all or a portion of the foregoing components may be integrated on a System on a Chip (SoC). Memory controller 406 is configured to facilitate access to system memory 413, which will usually be separate from the SoC. For example, system memory may comprise one or more memory devices supporting one or more memory standards, such as DRAM DIMMs (Dual Inline Memory Modules) having standardized form factors.

CPU core 404 includes M processor cores 414, each including a respective local level 1 (L1) cache 416 and a local level 2 (L2) cache 418 (the cores and the L1 and L2 caches 416 and 418 are depicted with subscripts indicating the core they are associated with, e.g., 416₁ and 418₁ for core 414₁). Optionally, the L2 cache may be referred to as a “middle-level cache” (MLC). As illustrated in this cache architecture, an L1 cache 416 is split into an L1 instruction cache 416₁ and an L1 data cache 416_{D} (e.g., 416₁₁ and 416_{1D} for core 414₁).

Computing platform 400 employs multiple agents that facilitate transfer of data between different levels of cache and memory. These include core agents 420, L1 agents 422, L2 agents 424, an L3 agent 426, and a memory agent 428. The L1, L2, and L3 agents are also used to effect one or more coherency protocols and to perform relating operations, such as snooping, marking cache line status, cache eviction, and memory writebacks. L3 agent 426 manages access to and use of L3 cache slots 430 (which are used to store respective cache lines). Data is also stored in memory 413 using memory cache lines 432. Memory cache lines that are part of the compressed partition are depicted as memory cache lines 434 and are used to store compressed data.

For simplicity, interconnect 412 is shown as a single double-ended arrow representing a single interconnect structure; however, in practice, interconnect 412 is illustrative of one or more interconnect structures within a processor or SoC or System on Package (SoP), and may comprise a hierarchy of interconnect segments or domains employing separate protocols and including applicable bridges for interfacing between the interconnect segments/domains. For example, the portion of an interconnect hierarchy to which memory and processor cores are connected may comprise a coherent memory domain employing a first protocol, while interconnects at a lower level in the hierarchy will generally be used for IO access and employ non-coherent domains. The interconnect structure on the processor or SoC may include any existing interconnect structure, such as buses and single or multi-lane serial point-to-point, ring, torus, or mesh interconnect structures (including arrays of rings or torus).

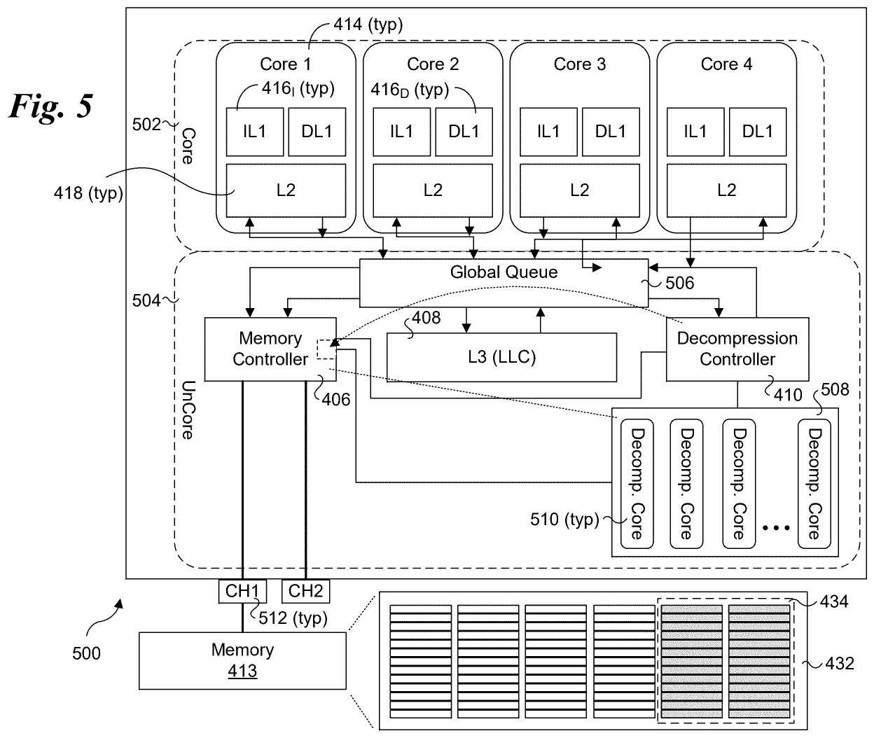

FIG. 5 shows an SoC 500 implementing a memory coherency architecture employed by the embodiment of FIG. 4. Under this and similar architectures, such as employed by some Intel® and AMD® processors, the L1 and L2 caches are part of a coherent memory domain under which memory coherency is managed by coherency mechanisms in the processor core 502. As in FIG. 4, each core 414 includes an L1 instruction (IL1) cache 416I, and L1 data cache (DL1) 416D, and an L2 cache 418. In some embodiments L2 caches 418 are non-inclusive, meaning they do not include copies of any cachelines in the L1 instruction and data caches for their respective cores. As an option, L2 may be inclusive of L1, or may be partially inclusive of L1. In addition, L3 may be inclusive of L1 and/or L2 or non-inclusive of L1/L2. Under another option, L1 and L2 may be replaced by a cache occupying a single level in cache hierarchy.

Meanwhile, the LLC is considered part of the “uncore” 504, wherein memory coherency is extended through coherency agents (e.g., L3 agent 426 and memory agent 428). As shown, uncore 504 (which represents the portion(s) of the SoC circuitry that is external to core 502) includes memory controller 406 coupled to external memory 413 and a global queue 506. Global queue 506 also is coupled to an L3 cache 408, and decompression controller 410. Memory controller 406 includes memory device interface circuitry comprising one or more memory channels (CH) 512. In some embodiments, a memory device, such as a DIMM may include input/output (I/O) circuitry for two memory channels, while other memory devices may provide I/O circuitry for a single memory channel.

As is well known, as you get further away from a core, the size of the cache levels increase, but so does the latency incurred in accessing cachelines in the caches. The L1 caches are the smallest (e.g., 32-80 KiloBytes (KB)), with L2 caches being somewhat larger (e.g., 256 KB to 2 MegaBytes (MB)), and LLCs being larger than the typical L2 cache by an order of magnitude or so (e.g., 30-100+MB). Of course, the size of these caches is dwarfed by the size of system memory (on the order of GigaBytes of even TeraBytes for some servers). Generally, the size of a cacheline at a given level in a memory hierarchy is consistent across the memory hierarchy, and for simplicity and historical references, lines of memory in system memory are also referred to as cache lines even though they are not actually in a cache. It is further noted that the size of global queue 506 is generally quite small, as it is designed to only momentarily buffer cachelines that are being transferred between the various caches, memory controller 406, and decompression controller 410.

Uncore 504 further includes a decompression block 508 comprising a plurality of decompression cores 510 coupled to decompression controller 410. Decompression cores 510 may also be referred to as decompression accelerators. Decompression cores 510 comprise circuitry for performing decompression operations on compressed data accessed from memory 413. Decompression controller 410 is used to control access to decompression cores 510. As further shown in FIG. 5, as an alternative to having a separate circuitry block for decompression controller 410, circuitry for implementing the functionality for a decompression controller may be included as part of memory controller 406. As yet another option, both a decompression controller and decompression cores 510 may be implemented as part of memory controller 406.

As an option to hardware decompression, software decompression may used. Under these embodiments, the hardware architecture of FIGS. 4 and 5 may or may not include a decompression controller and decompression cores. Under one embodiment, decompression is managed by a component in the operating system.

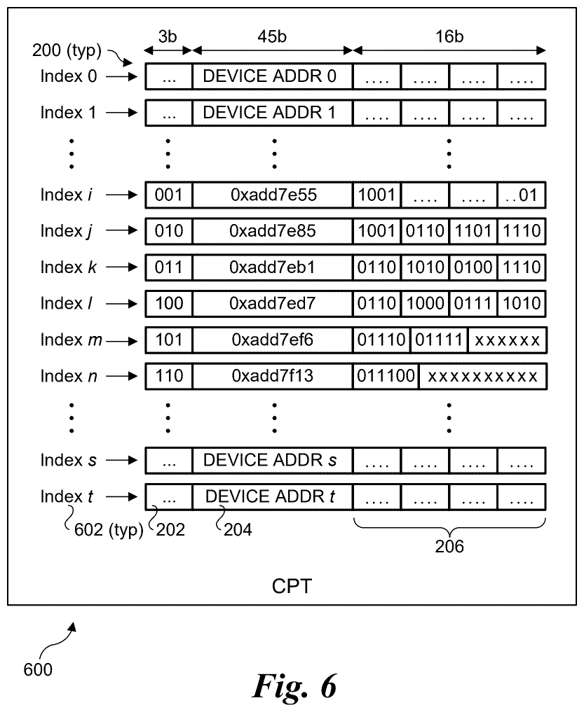

FIG. 6 shows a CPT 600, according to one embodiment. CPT 600 includes a plurality of CPT entries 200 having the same fields as CPT entry 200 shown in FIG. 2 and discussed above. Each CPT entry has an index 602. In one embodiment, PHYS_C addresses are assigned consecutively (which is determined by the OS memory allocator) and a function is used to calculate the index of the CPT entry belonging to a PHYS_C page. For example, if the compressed partition starts at address A_C, the CPT entry index can be found by taking (PHYS_C-A_C)/4096, e.g., subtract the partition start from the PHYS_C address and integer divide by 4K to transform to “page units.”. The CPT should be large enough to hold all compressed pages.

If PHYS_C pages are not assigned consecutively, this indexing might create “holes” in the CPT, which makes it less efficient in terms of memory usage. In this case, there can be a “PHYS_C” tag in the CPT itself to tighten the holes, in combination with a hash function to avoid walking over all CPT entries. In an alternative embodiment, this approach is used.

The device address is used to locate the memory controller, DRAM chip, DIMM, bank, etc., by using parts of the address to index these structures. In one embodiment, after the compressed chunk is located using the CPT, the decompression engine sends multiple 64 B data fetch requests to the memory subsystem to fetch the chunk, the location of which is determined by the device address (each 64 B block could even be in a different location, depending on how addresses are interleaved between memory controllers and memory chips). Optionally, a software component (e.g., agent or operating system component) sends multiple 64 B data fetch requests to the memory subsystem to fetch the chunk, the location of which is determined by the device address.

The example CPT entries with indexes i, j, k, l, m, and n respectively correspond to the compression schemes 300a, 300b, 300c, 300d, 300e, and 300f when the examples in these diagrams are stored back-to-back. The delta between device addresses for pairs of sequential entries is equal to the aggregate compressed size of the first page in the pair. Thus, while the PHYS_C addresses for consecutive pages are 4K (4096 B) apart, the device addresses for consecutive pages will be less than 4K and will vary.

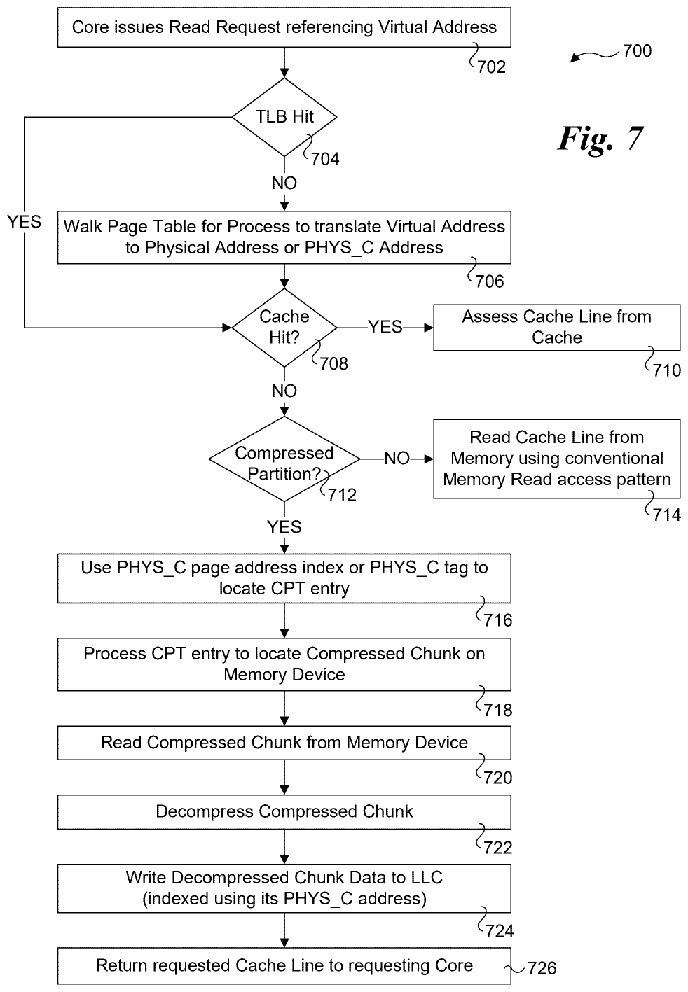

FIG. 7 shows a flowchart 700 illustrating operations and logic perform for a Read request to access data. The process begins in a block 702 with a core issuing a Read request referencing a virtual address of a requested cache line. Rather than use physical memory with physical addressing, operating systems utilize virtual memory with virtual addressing. However, since the memory devices themselves utilize physical addressing, there needs to be a translation from the virtual address of the cache line to the physical address of the cache line. Coherent cache architectures employ Translation Look-aside Buffers (TLBs) that contain page-table entries that map virtual addresses to physical addresses. A TLB may be implemented as a content-addressable memory (CAM). The CAM search key is the virtual address, and the search result is the physical address. If the requested virtual address is present in the TLB, the CAM search yields a match quickly and the retrieved physical address can be used to access memory. This is called a TLB hit.

As shown in a decision block 704 a determination is made to whether there is a TLB hit. For some cache designs, there may be multiple TLBs that are searched. If there is a hit for any of the TLBs, the answer to decision block 704 is YES and the physical address of the cache line is determined using a virtual-to-physical address translation. For example, the physical address may be an address offset from the start of a physical page address for a page table entry in a TLB. The physical address is then used to determine whether the cache line is present in one of the cache levels (L1, L2, or L3). As depicted by a decision block 708, if the cache line is present in a cache the result is a cache hit, and the cache line is accessed from the cache in a block 710.

For illustrative purposes, the TLB hit and cache hit approach shown here is a simplified representation of how a cache line that is cached on-chip (in a local L1/L2 cache or shared LLC) is accessed. Well-known operations such as snoops and the like are not shown for simplicity, but will be understood by those skilled in the art to be used in accordance with the coherent memory architecture of a given system design.

If there is not a TLB hit, the logic proceeds to a block 706 where the page table for the process (requesting the cache line) is identified and walked to translate the virtual address to a physical address or PHYS_C address. This uses the conventional page table walker implemented by existing operating systems, where the processID or virtual address may be used to identify the applicable page table (for the process) to walk. Block 706 returns a physical address corresponding to the physical address of the cache line in plain DRAM or a PHYS_C address used for accessing a cache line in the compressed partition.

The physical address or PHYS_C address is then used to determine whether the cache line is present in an L1, L2, or L3 cache. If there is a cache hit, the cache line is access from the cache in block 710, as before. If there is a cache miss, the answer to decision block 708 is NO and the logic proceeds to a decision block 712 to determine whether the cache line is in the compressed partition. In one embodiment the memory controller utilizes the most significant (MS) bits of the physical address or PHYS_C address to determine where the cache line is located in the compressed partition. If the answer is NO, the cache line is in plain (uncompressed) memory, and the cache line is read from the applicable memory device using a conventional memory read access pattern, as depicted in a block 714.

If the cache line is in the compressed partition, the answer to decision block 712 is YES and the logic proceeds to a block 716 in which an index derived using the PHYS_C address or a PHYS_C tag is used to locate a CPT entry in the CPT. In a block 718 information in the CPT entry is used to locate the compressed chunk on a memory device in system memory. As described above, the device address in the CPT entry is used to locate the start of the compressed page in memory, including the memory device containing that compressed page. For a memory controller supporting multiple memory channels, the memory controller will also identify what memory channel is used to access the memory device. The encoded chunk size 202 and fields 206 denoting the sizes of each compressed chunk is used to identify the offset of the compressed chunk from the start of the compressed page and the size of the compressed chunk.

The compressed chunk is then read from the memory device in a block 720. As described above, in alternate embodiments the decompression engine or a software component sends multiple 64 B data fetch requests to the memory subsystem to fetch the compressed chunk. The data in the compressed chunk are decompressed in a block 722 to obtain uncompressed data comprising multiple 64 B cache lines. In some embodiments decompression is performed in hardware, such as using a decompression core or other type of decompression accelerator. Optionally, decompression may be done using software.

In a block 724 the decompressed chunk data are written to the LLC as new cache lines and indexed using the PHYS_C address. The process is completed in a block 726 by returning the requested cache line to the requesting core using a conventional LLC access pattern. For example, in one embodiment cache agents for the LLC and L1/L2 caches copy the cache line from the LLC to the L2 cache and the L1 Instruction cache or L1 Data cache. Under other cache architectures, the cache line may be copied to the L1 Instruction cache or L1 Data cache without copying the cache line to the L2 cache.

In the foregoing description, reference is made to a compressed chunk. As described and illustrated in the examples above, a compressed page may contain both compressed chunks and uncompressed chunks. Data contained in an uncompressed chunk in a compressed page is accessed in a similar manner to data in a compressed chunk, accept there is no decompression of that data. Thus, in block 720 the uncompressed chunk of data would be read, block 722 would be skipped, and in block 724 the chunk of uncompressed data will be written to the LLC.

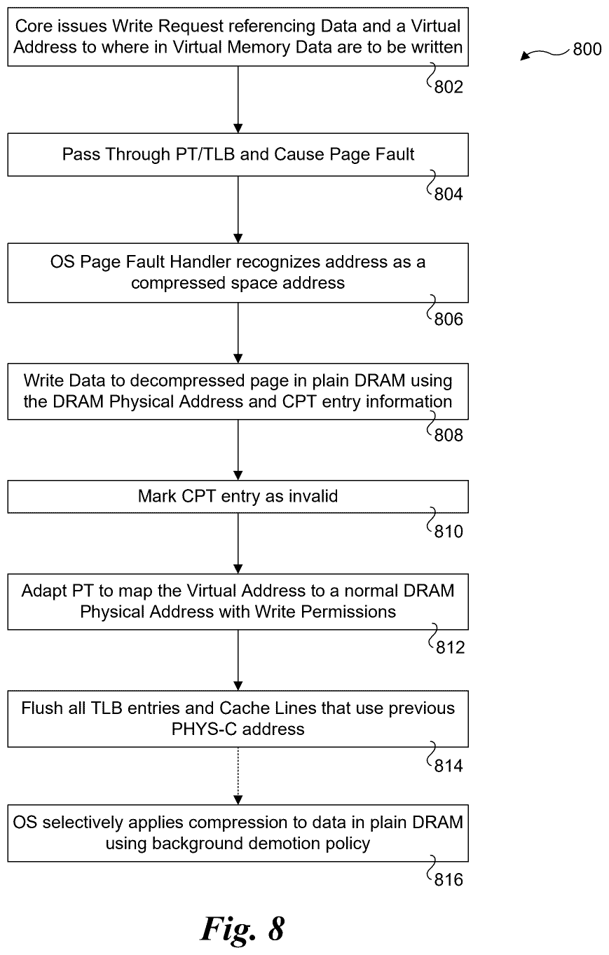

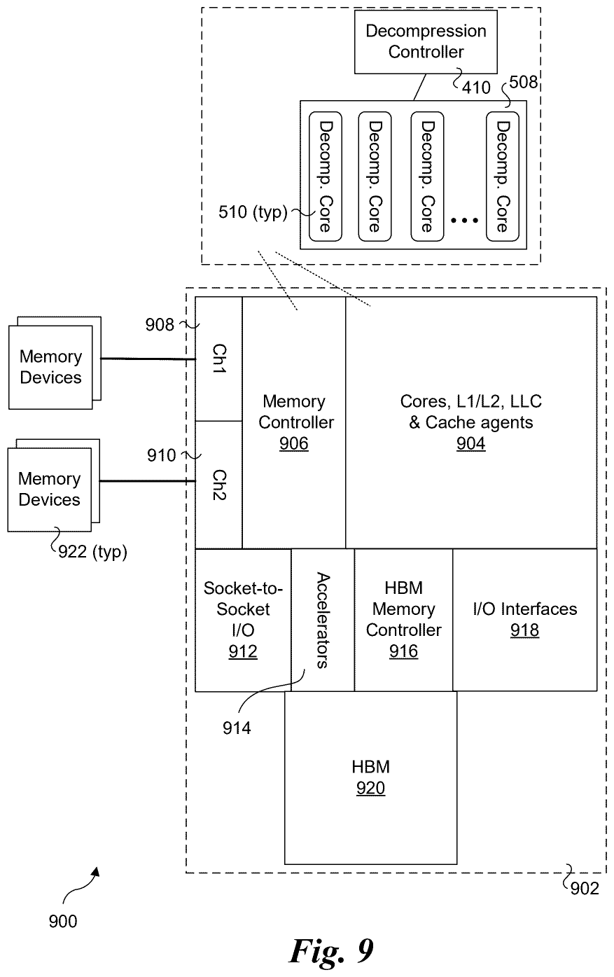

FIG. 8 shows a flowchart 800 illustrating operations performed to service a memory Write request that is to be written to memory in the compressed partition. In a block 802 a core issues a Write request referencing data and a virtual address identifying where in virtual memory the data are to be written. In a block 804 the request will pass through the PT/TLB processing and cause a page fault, because the entry is marked read-only (even if the cache line is cached locally, the page fault occurs). In a block 806 the OS page fault handler recognizes the address as a compressed space address (as opposed to a write to a regular read-only page, which should cause an exception) and initiates the memory Write to the compressed partition using the normal ZRAM/ZSWAP operation. This includes decompressing the page and putting the page in plain DRAM, and adapting the PT to map the virtual address to a normal DRAM physical address with write permissions, as shown in blocks 808 and 812.

In further detail, in block 808 the data are written to that DRAM physical address in plain DRAM using the CPT entry information. First, the CPT entry information is used to locate the start of the compressed page in the memory system. For each chunk in the compressed page, the chunk data are decompressed for compressed chunks or read for uncompressed chunks with the decompressed and uncompressed chunk data being written sequentially to the page in DRAM, resulting in writing 4K worth of data to the page in DRAM. Upon writing the compressed data to plain DRAM, the CPT entry for the compressed page is marked as invalid in a block 810. As described above, a chunk bit mode value of ‘000’ identifies the chunk is invalid. In a block 814 the TLB entries and cache lines that use the previous PHYS_C address are flushed.

Subsequently, the operating system may selectively apply compression to data in plain DRAM using a background demotion policy, as shown in a block 816. This may be accomplished using various schemes. Generally, for a given uncompressed page of data in plain DRAM the data may be written into a compressed page in memory in the compressed partition using any of the compression schemes describe and illustrated herein. One approach is to write compressed data to a new location in the compressed partition that has not been previously used. This is advantageous for its simplicity, but may result in holes in the utilization of the compressed partition with corresponding CPT entries marked as invalid. Such holes may be addressed in different ways, if at all.

One approach to addressing holes could be performed periodically to consolidate memory utilization in a compressed partition so that the compressed pages are written sequentially without holes. This approach is somewhat analogous to storage defragmentation schemes, under which collections of fragmented storage for one or more files are defragmented such that the file(s) is/are stored in a contiguous portion of storage space. Under this approach, existing compressed pages would be moved to fill in the holes. This would also create new CPT entries, as applicable.

FIG. 9 shows a system 900 including a System-on-Package (SoP) 902. SoP 902 includes a block or tile 904 including multiple cores, L1/L2 caches, an LLC, and cache agents, a memory controller 906 including memory channels 908 and 910, a socket-to-socket I/O interface 912, accelerators 914, a high bandwidth (HBM) memory controller 916, an I/O interfaces block 918 and HBM 920. Each of memory channels 908 and 910 is coupled to one or more memory devices 922. As depicted at the top of FIG. 9, decompression controller 410 and decompression cores or accelerators 510 in decompression block 508 may be integrated on memory controller 906 or on block or tile 904.

In one embodiment accelerators 914 include a plurality of decompression accelerators and compression accelerators, which are separate from decompression cores or accelerators 510. In a non-limiting example, accelerators 914 may be used for software-controlled compression and decompression, such as implemented using ZRAM and ZSWAP. In some embodiments accelerators 914 represent accelerators associated with one of more of Intel® IAA, QAT (QuickAssist Technology), and/or DLB (Dynamic Load Balancer).

Memory devices 922 represent volatile memory. Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3) JESD79-3F, originally published by JEDEC (Joint Electronic Device Engineering Council) in June 2007. DDR4 (DDR version 4), JESD209-4D, originally published in September 2012, DDR5 (DDR version 5), JESD79-5B, originally published in June 2021, DDR6 (DDR version 6), currently in discussion by JEDEC, LPDDR3 (Low Power DDR version 3, JESD209-3C, originally published in August 2015, LPDDR4 (LPDDR version 4, JESD209-4D, originally published in June 2021), LPDDR5 (LPDDR version 5, JESD209-5B, originally published in June 2021), WIO2 (Wide Input/Output version 2), JESD229-2, originally published in August 2014, HBM (High Bandwidth Memory, JESD235B, originally published in December 2018, HBM2 (HBM version 2, JESD235D, originally published in March 2021, HBM3 (HBM version 3, JESD238A originally published in January 2023) or HBM4 (HBM version 4), currently in discussion by JEDEC, or others or combinations of memory technologies, and technologies based on derivatives or extensions of such specifications. The JEDEC standards are available at www.jedec.org.

Memory devices 922 are representative of either memory chips supporting on or more of the foregoing standards and/or packaged memory devices including such memory chips, such as DIMMs, SODIMMs (Small Outline DIMMs) and CAMM (Compression Attached Memory Modules) devices. Generally, DIMMs, SODIMMs and CAMM devices will be installed in or attached to mating connectors on a system board or the like in which an SoC or SoP is installed.

HBM 920 is representative of existing and future HBM memory devices supporting one or more of HTM, HBM2, HBM3, and/or HBM4. HBM memory may be tightly coupled with other circuitry in an SoP package, such as using a stacked 3D architecture or a tile or chiplet architecture. For example, all the circuit blocks/tiles shown for SoP 902 except for HBM 920 may comprise an SoC or the like, with HBM 920 coupled to the SoC.

Socket-to-Socket I/O interfaces 912, which are optional, are used to support socket-to-socket communication in a multi-socket platform. Non-limiting examples of multiple socket platforms may include 2 sockets, 4 sockets, or more sockets. Under the terminology “socket” used here, an instance of SoP 902 would be installed in a respective socket on a system board or the like or could be directly mounted to the system board. In the art, the term “socket” in a multi-socket platform refers to a processor, SoC, or SoP whether the processor, SoC, or SoP is installed in a socket or mounted to a system board without a socket. When there are 4 or more sockets, the socket-to-socket communication paths may be arranged in a daisy-chain, a daisy-chain with cross connections and/or variations thereof.

The I/O interfaces in I/O interface block 918 are generally illustrative of I/O interfaces configured in accordance with one or more I/O standards. This includes any type of I/O interface, such as but not limited to Peripheral Component Interconnect express (PCIe), Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

The following examples pertain to additional examples of the teachings and principles disclosed herein.

Example 1. An example method can be implemented on a computing platform including a processor having multiple cores and coupled to system memory comprising one or more memory devices and hosting an operating system. A physical address space for the system memory is partitioned to include an uncompressed partition in which data are stored without compression and a compressed partition in which compressed data are stored. Compressed data are stored in the compressed partition using a plurality of chunk sizes. In response to a first memory Read request for first data issued by a core, a determination is made to whether the first data are stored in the compressed partition. When the first data are determined to be stored in the compressed partition, the location of a first compressed chunk on a memory device containing the first data is determined, the first compressed chunk is decompressed to obtain decompressed data including the first data, and the first data are returned to the core issuing the first memory Read request.

Example 2. The method of claim 1, wherein the determination of the location of the first compressed chunk comprises determining a location of a compressed page of memory on the memory device containing the first compressed chunk and determining the location of the first compressed chunk within the compressed page.

Example 3. The method of claim 1 or 2, further comprising, for each of a plurality of compressed pages in the compressed partition, employing one or more compressed chunks having a fixed uncompressed size.

Example 4. The method of claim 3, wherein the uncompressed chunk sizes of chunks stored in the compressed partition include three or more of: 128 B chunks, 256 B chunks, 512 B chunks, 1024 B chunks, 2048 B chunks, and 4096 B chunks.

Example 5. The method of claim 3 or 4, further comprising maintaining a compressed page table (CPT) comprising respective entries for compressed pages.

Example 6. The method of claim 5, wherein a CPT entry includes one or more of, a field containing an encoded uncompressed chunk size for the compressed page, a field containing a device address corresponding to a start of the compressed page, and one or more fields denoting sizes of each chunk in the compressed page, wherein at least a portion of the chunks in a compressed page comprise compressed chunks containing compressed data.

Example 7. The method of claim 5 or 6, further comprising defining a physical address space for the compressed partition as a compressed physical space containing addresses to compressed data as if those data were not compressed where a byte in the compressed physical space maps to a byte in uncompressed data, and maintaining, for each of one or more page tables (PTs), mappings for virtual addresses of memory pages in an uncompressed partition in the physical address space to physical addresses of those memory pages, and mappings for virtual addresses of memory pages in the compressed partition to compressed physical space addresses for those memory pages.

Example 8. The method of claim 7, wherein the first memory Read request issued by the core references a virtual address of the first data, and each entry in the CPT contains an index, further comprising walking a PT to identify a compressed physical space address of a compressed page associated with the virtual address of the first data using the compressed physical space address to obtain an index, and using the index to locate a CPT entry for the compressed page.

Example 9. The method of any of claims 6-8, further comprising in response to determining data for a page in the uncompressed partition are to be written to a compressed page in the compressed partition, determining an uncompressed chunk size to be used for the compressed page, writing data to the compressed page as a sequence of chunks utilizing the uncompressed chunk size, at least a portion of chunks in the sequence of chunks comprising compressed chunks, generating a new entry or updating an existing entry in the compressed page table having fields corresponding to the compressed page.

Example 10. The method of any of the preceding claims, wherein at least a portion of compressed pages in the compressed partition contain a combination of compressed chunks containing compressed data and uncompressed chunks containing uncompressed data, further comprising, in response to a second memory Read request for second data issued by a core, determining whether the second data are stored in the compressed partition. When the first data are determined to be stored in the compressed partition, the location of a first compressed chunk on a memory device containing the first data is determined, the first compressed chunk is decompressed to obtain decompressed data including the first data, and the first data are returned to the core issuing the first memory Read request.

Example 11. The method of any of the preceding claims, wherein the determination that data are stored in the compressed partition is made by hardware logic on the processor.

Example 12. The method of any of the preceding claims, wherein the processor includes one or more decompression cores or decompression accelerators, and a decompression core or decompression accelerator is used to decompress the first compressed chunk.

Example 13. The method of any of the preceding claims, wherein, for at least one compressed page in the compressed partition, the page includes compressed chunks having at least two different sizes.

Example 14. The non-transitory machine-readable medium having instructions stored thereon configured to be executed on one or more cores of a multiple processor of a computing platform having multiple cores and coupled to system memory comprising one or more memory devices, wherein execution of the instructions enabled the computing platform to partition a physical address space for the system memory to include an uncompressed partition in which data are stored without compression and a compressed partition in which compressed data are stored, and store compressed data in the compressed partition using a plurality of chunk sizes, wherein for each of a plurality of compressed pages in the compressed partition, employing one or more compressed chunks having a fixed uncompressed size.

Example 15. The non-transitory machine-readable medium of claim 13, wherein execution of the instructions further enables the system to, in response to a first memory Read request for first data stored in the compressed partition and issued by a core determine a location of a first compressed chunk on a memory device containing the first data, retrieve the first compressed chunk from the memory device; and one of decompress the first compressed chunk to obtain decompressed data including the first data or instruct the processor to perform hardware decompression using an accelerator on the processor obtain decompressed data including the first data.

Example 16. The non-transitory machine-readable medium of claim 15, wherein execution of the instructions further enables the system to determine a location of a compressed page of memory on the memory device containing the first compressed chunk, and determining the location of the first compressed chunk within the compressed page.

Example 17. The non-transitory machine-readable medium of any of claims 14-16, wherein execution of the instructions further enables the system to maintain a compressed page table (CPT) comprising respective entries for compressed pages.

Example 18. The non-transitory machine-readable medium of claim 17, wherein a (CPT) entry includes one or more of a field containing an encoded uncompressed chunk size for the compressed page, a field containing a device address corresponding to a start of the compressed page, and one or more fields denoting sizes of each chunk in the compressed page, wherein at least a portion of the chunks in a compressed page comprise compressed chunks containing compressed data.

Example 19. The non-transitory machine-readable medium of claim 16, wherein execution of the instructions further enables the system to define a physical address space for the compressed partition as a compressed physical space containing addresses to compressed data as if those data were not compressed where a byte in the compressed physical space maps to a byte in uncompressed data, and maintain, for each of one or more page tables (PTs), mappings for virtual addresses of memory pages in an uncompressed partition in the physical address space to physical addresses of those memory pages, and mappings for virtual addresses of memory pages in the compressed partition to compressed physical space addresses for those memory pages.

Example 20. The non-transitory machine-readable medium of claim 19, wherein a first memory Read request issued by the core references a virtual address of first data and each entry in the CPT contains an index, wherein execution of the instructions further enables the system to walk a PT to identify a compressed physical space address of a compressed page associated with the virtual address of the first data, utilize the compressed physical space address to obtain an index, and utilize the index to locate a CPT entry for the compressed page.

Example 21. The non-transitory machine-readable medium of any of claims 17-19, wherein execution of the instructions further enables the system to determine data for a page in the uncompressed partition are to be written to a compressed page in the compressed partition, determine an uncompressed chunk size to be used for the compressed page, write data to the compressed page as a sequence of chunks utilizing the uncompressed chunk size, at least a portion of chunks in the sequence of chunks comprising compressed chunks, and generate a new entry or updating an existing entry in the CPT having fields corresponding to the compressed page.

Example 22. The non-transitory machine-readable medium of any of claims 14-21, wherein execution of the instructions further enables the system to determine data for multiple pages in the uncompressed partition are to be written to respective compressed pages in the compressed partition, employ at least three different uncompressed chunk sizes for pages among the respective compressed pages from among uncompressed chunk sizes of: 128 B chunks, 256 B chunks, 512 B chunks, 1024 B chunks, 2048 B chunks, and 4096 B chunks.

Example 23. A system comprising system memory comprising a plurality of memory devices, software comprising executable instructions associated with an operating system and processes for applications to be run on the operating system, a multi-core processor comprising, multiple processor cores having associated level 1 (L1) and level 2 (L2) caches, and a memory controller having an interface comprising one or more memory channels coupled to one or more of the plurality of memory devices. The system is configured to, partition a physical address space for the system memory to include an uncompressed partition in which data are stored without compression and a compressed partition in which compressed data are stored, store compressed data in the compressed partition using a plurality of chunk sizes, issue a first memory Read request for first data via execution of instructions for a process on a core, and determine whether the first data are stored in the compressed partition. When the first data are determined to be stored in the compressed partition, the location of a first compressed chunk on a memory device containing the first data is determined, the first compressed chunk is decompressed to obtain decompressed data including the first data, and the first data are returned to the core issuing the first memory Read request.

Example 24. The system of claim 23, further configured to, for each of a plurality of compressed pages in the compressed partition, employ one or more compressed chunks having a fixed uncompressed size, maintain a compressed page table (CPT) comprising respective entries for compressed pages having, a field containing an encoded uncompressed chunk size for the compressed page, a field containing a device address corresponding to a start of the compressed page, and one or more fields denoting sizes of each chunk in the compressed page, wherein at least a portion of the chunks in a compressed page comprise compressed chunks containing compressed data.

Example 25. The system of claim 23 or 24, further configured to define a physical address space for the compressed partition as a compressed physical space containing addresses to compressed data as if those data were not compressed where a byte in the compressed physical space maps to a byte in uncompressed data, and maintain, for each of one or more page tables (PTs), mappings for virtual addresses of memory pages in an uncompressed partition in the physical address space to physical addresses of those memory pages, and mappings for virtual addresses of memory pages in the compressed partition to compressed physical space addresses for those memory pages.

Example 26. The system of claim 25, wherein the first memory Read request issued by the core references a virtual address of the first data, and each entry in the CPT contains an index, further configured to access a PT to identify a compressed physical space address of a compressed page associated with the virtual address of the first data, utilize the compressed physical space address to obtain an index, and utilize the index to locate a CPT entry for the compressed page.

The system of any of claims 23-26, further configured to determine data for a page in the uncompressed partition are to be written to a compressed page in the compressed partition, determine an uncompressed chunk size to be used for the compressed page, write data to the compressed page as a sequence of chunks utilizing the uncompressed chunk size, at least a portion of chunks in the sequence of chunks comprising compressed chunks, and generate a new entry or update an existing entry in the compressed page table having fields corresponding to the compressed page.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

The operations and functions performed by various components described herein may be implemented by embedded software/firmware running on a processing element, via embedded hardware or the like, or a combination of hardware and software/firmware. Such components may be implemented as software or firmware modules, hardware modules, special-purpose hardware (e.g., application specific hardware, ASICs, DSPs, etc.), embedded controllers, hardwired circuitry, hardware logic, etc. Software/firmware content (e.g., data, instructions, configuration information, etc.) may be provided via an article of manufacture including non-transitory computer-readable or machine-readable storage medium, which provides content that represents instructions that can be executed. The content may result in a computer or platform performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the claims to the precise forms disclosed. While specific embodiments of, and examples are described herein for illustrative purposes, various equivalent modifications are possible within the scope of the claims, as those skilled in the relevant art will recognize.

These modifications can be made in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method implemented on a computing platform including a processor having multiple cores and coupled to system memory comprising one or more memory devices and hosting an operating system, comprising:
partitioning a physical address space for the system memory to include an uncompressed partition in which data are stored without compression and a compressed partition in which compressed data are stored;
storing compressed data in the compressed partition using a plurality of chunk sizes, each chunk in the compressed partition storing a respective portion of data;
in response to a first memory Read request for first data issued by a core, determining whether the first data are stored in the compressed partition; and
when the first data are determined to be stored in the compressed partition,
a) determining a location of a first compressed chunk on a memory device containing the first data;
b) retrieving the first compressed chunk from the memory device;
c) decompressing the first compressed chunk to obtain decompressed data including the first data; and
d) returning the first data to the core issuing the first memory Read request.

2. The method of claim 1, wherein the determination of the location of the first compressed chunk comprises:
determining a location of a compressed page of memory on the memory device containing the first compressed chunk; and
determining the location of the first compressed chunk within the compressed page.

3. The method of claim 1, further comprising, for each of a plurality of compressed pages in the compressed partition, employing one or more compressed chunks having a fixed uncompressed size.

4. The method of claim 3, further comprising maintaining a compressed page table (CPT) comprising respective entries for compressed pages.

5. The method of claim 4, further comprising:
defining a physical address space for the compressed partition as a compressed physical space containing addresses to compressed data as if those data were not compressed where a byte in the compressed physical space maps to a byte in uncompressed data; and
maintaining, for each of one or more page tables (PTs),
mappings for virtual addresses of memory pages in an uncompressed partition in the physical address space to physical addresses of those memory pages; and
mappings for virtual addresses of memory pages in the compressed partition to compressed physical space addresses for those memory pages.

6. The method of claim 5, wherein the first memory Read request issued by the core references a virtual address of the first data, and each entry in the CPT contains an index, further comprising:
accessing a PT to identify a compressed physical space address of a compressed page associated with the virtual address of the first data;
using the compressed physical space address to obtain an index; and
using the index to locate a CPT entry for the compressed page.

7. The method of claim 4, further comprising:
in response to determining data for a page in the uncompressed partition are to be written to a compressed page in the compressed partition,
determining an uncompressed chunk size to be used for the compressed page;
writing data to the compressed page as a sequence of chunks utilizing the uncompressed chunk size, at least a portion of chunks in the sequence of chunks comprising compressed chunks; and
generating a new entry or updating an existing entry in the compressed page table.

8. The method of claim 1, wherein at least a portion of compressed pages in the compressed partition contain a combination of compressed chunks containing compressed data and uncompressed chunks containing uncompressed data, further comprising:
in response to a second memory Read request for second data issued by a core, determining whether the second data are stored in the compressed partition; and
when the second data are determined to be stored in the compressed partition,
a) determining a location of a chunk on a memory device containing the second data;
b) determining the chunk containing the second data is an uncompressed chunk; and
c) returning the second data in the uncompressed chunk to the core issuing the second memory Read request.

9. A non-transitory machine-readable medium having instructions stored thereon configured to be executed on one or more cores of a multiple processor of a computing platform having multiple cores and coupled to system memory comprising one or more memory devices, wherein execution of the instructions enabled the computing platform to:
partition a physical address space for the system memory to include an uncompressed partition in which data are stored without compression and a compressed partition in which compressed data are stored; and
store compressed data in the compressed partition using a plurality of chunk sizes, wherein for each of a plurality of compressed pages in the compressed partition, employing one or more compressed chunks having a fixed uncompressed size.

10. The non-transitory machine-readable medium of claim 9, wherein execution of the instructions further enables the system to:
in response to a first memory Read request for first data stored in the compressed partition and issued by a core,
a) determine a location of a first compressed chunk on a memory device containing the first data;
b) retrieve the first compressed chunk from the memory device; and
c) one of decompress the first compressed chunk to obtain decompressed data including the first data or instruct the processor to perform hardware decompression using an accelerator on the processor obtain decompressed data including the first data.

11. The non-transitory machine-readable medium of claim 10, wherein execution of the instructions further enables the system to:
determine a location of a compressed page of memory on the memory device containing the first compressed chunk; and
determining the location of the first compressed chunk within the compressed page.

12. The non-transitory machine-readable medium of claim 9, wherein execution of the instructions further enables the system to maintain a compressed page table (CPT) comprising respective entries for compressed pages.

13. The non-transitory machine-readable medium of claim 12, wherein execution of the instructions further enables the system to:
define a physical address space for the compressed partition as a compressed physical space containing addresses to compressed data as if those data were not compressed where a byte in the compressed physical space maps to a byte in uncompressed data; and
maintain, for each of one or more page tables (PTs),
mappings for virtual addresses of memory pages in an uncompressed partition in the physical address space to physical addresses of those memory pages; and
mappings for virtual addresses of memory pages in the compressed partition to compressed physical space addresses for those memory pages.

14. The non-transitory machine-readable medium of claim 13, wherein a first memory Read request issued by the core references a virtual address of first data and each entry in the CPT contains an index, wherein execution of the instructions further enables the system to:
access a PT to identify a compressed physical space address of a compressed page associated with the virtual address of the first data;
utilize the compressed physical space address to obtain an index; and
utilize the index to locate a CPT entry for the compressed page.

15. The non-transitory machine-readable medium of claim 12, wherein execution of the instructions further enables the system to:
determine data for a page in the uncompressed partition are to be written to a compressed page in the compressed partition;
determine an uncompressed chunk size to be used for the compressed page;
write data to the compressed page as a sequence of chunks utilizing the uncompressed chunk size, at least a portion of chunks in the sequence of chunks comprising compressed chunks; and
generate a new entry or updating an existing entry in the compressed page table.

16. A system comprising:
system memory comprising a plurality of memory devices;
software comprising executable instructions associated with an operating system and processes for applications to be run on the operating system;
a multi-core processor comprising,
multiple processor cores having associated level 1 (L1) and level 2 (L2) caches; and
a memory controller having an interface comprising one or more memory channels coupled to one or more of the plurality of memory devices;
wherein the system is configured to,
partition a physical address space for the system memory to include an uncompressed partition in which data are stored without compression and a compressed partition in which compressed data are stored;
store compressed data in the compressed partition using a plurality of chunk sizes, each chunk in the compressed partition storing a respective portion of data;
issue a first memory Read request for first data via execution of instructions for a process on a core,
determine whether the first data are stored in the compressed partition; and
when the first data are determined to be stored in the compressed partition,
a) determine a location of a first compressed chunk on a memory device containing the first data;
b) retrieve the first compressed chunk from the memory device;
c) decompress the first compressed chunk to obtain decompressed data including the first data; and
d) return the first data to the core issuing the first memory Read request.

17. The system of claim 16, further configured to:
for each of a plurality of compressed pages in the compressed partition, employ one or more compressed chunks having a fixed uncompressed size maintain a compressed page table (CPT) comprising respective entries.

18. The system of claim 17, further configured to:
define a physical address space for the compressed partition as a compressed physical space containing addresses to compressed data as if those data were not compressed where a byte in the compressed physical space maps to a byte in uncompressed data; and
maintain, for each of one or more page tables (PTs),
mappings for virtual addresses of memory pages in an uncompressed partition in the physical address space to physical addresses of those memory pages; and
mappings for virtual addresses of memory pages in the compressed partition to compressed physical space addresses for those memory pages.

19. The system of claim 18, wherein the first memory Read request issued by the core references a virtual address of the first data, and each entry in the CPT contains an index, further configured to:
access a PT to identify a compressed physical space address of a compressed page associated with the virtual address of the first data;
utilize the compressed physical space address to obtain an index; and
utilize the index to locate a CPT entry for the compressed page.

20. The system of claim 17, further configured to:
determine data for a page in the uncompressed partition are to be written to a compressed page in the compressed partition,
determine an uncompressed chunk size to be used for the compressed page;
write data to the compressed page as a sequence of chunks utilizing the uncompressed chunk size, at least a portion of chunks in the sequence of chunks comprising compressed chunks; and
generate a new entry or update an existing entry in the compressed page table.
